(19) United States
(12) Patent Application Publication
(10) Pub. No.: US 2025/0366460 A1
(43) Pub. Date: Dec. 4, 2025

(54) SYSTEMS AND METHODS OF TERMITE CONTROL INCLUDING USE OF A MATERIAL WITH TERMITE CHEMICAL PLACED WITHIN A CARDBOARD STRUCTURE

(71) Applicant: Donna Lamberth, Statesville, NC (US)

(72) Inventor: Donna Lamberth, Statesville, NC (US)

(21) Appl. No.: 19/192,201

(22) Filed: Apr. 28, 2025

Related U.S. Application Data
(60) Provisional application No. 63/652,208, filed on May 28, 2024.

(51) Int. Cl. A01M 1/20

(52) U.S. Cl. CPC A01M 1/2011

(57) ABSTRACT

Systems and methods of termite control including use of a material with termite chemical placed within a cardboard structure are disclosed. According to an aspect, the system includes a structure having an interior surface. The system also includes a loose material with termite chemical mixed therein. The loose material is placed on the interior surface. Further, the system can be placed in a termite pathway.

### CROSS-REFERENCE TO RELATED APPLICATIONS

This application claims priority to U.S. Provisional Patent Application No. 63/652,208, filed May 28, 2024, titled SYSTEMS AND METHODS OF TERMITE CONTROL INCLUDING USE OF A MATERIAL WITH TERMITE CHEMICAL PLACED WITHIN A CARDBOARD STRUCTURE, the disclosure of which is incorporated herein by reference in its entirety.

### BACKGROUND

Pest control involves the management and regulation of unwanted organisms, generally referred to as “pests,” that can pose threats to property, human health, and the environment. Pests include, but are not limited to, insects, rodents, birds, and other organisms that interfere with human activities or cause damage.

With regard to households and other buildings, termites are a significant problem in the United States, primarily due to their ability to cause extensive damage to wooden structures. The main issue with termites is that they often go unnoticed until serious damage has already occurred. Some studies indicates that termites and similar pests cause an estimated $30 billion in damage.

One of the challenges with termite infestations is that they can be difficult to detect. Termites typically operate silently and can remain hidden within walls, floors, and other inaccessible areas. As a result, homeowners may not realize they have a termite problem until significant damage has already been done.

Controlling termites may require a combination of preventative measures, such as maintaining proper moisture levels around the home and eliminating wood-to-soil contact, as well as treatment options such as chemical barriers or baiting systems. Regular inspections by pest control professionals are also essential for detecting termite activity early and implementing appropriate measures to mitigate damage.

In view of the foregoing, there is a continuing need for improved systems and techniques for managing termites in households and other buildings.

### SUMMARY OF THE DISCLOSURE

The presently disclosed subject matter relates to systems and methods of termite control including use of a material with termite chemical placed within a cardboard structure. According to an aspect, the system includes a structure having an interior surface. The system also includes a loose material with termite chemical mixed therein. The loose material is placed on the interior surface. Further, the system can be placed in a termite pathway.

### BRIEF DESCRIPTION OF DRAWINGS

Having thus described the presently disclosed subject matter in general terms, reference will now be made to the accompanying Drawings, which are not necessarily drawn to scale, and wherein:

FIG. 1 is a perspective view of a system including a structure containing a loose material with termite chemical mixed therein for termite control in accordance with embodiments of the present disclosure;

FIG. 2 is a side view of the structure shown in FIG. 1 with a loose material with termite chemical mixed therein;

FIG. 3 is the structure containing a dirt and termite chemical mixture deployed in a crawlspace in accordance with embodiments of the present disclosure;

FIG. 4 is a view of the structure containing a dirt and termite chemical mixture deployed between two pillars in accordance with embodiments of the present disclosure;

FIG. 5 is a view of the structure containing a dirt and termite chemical mixture deployed in a crawlspace on top of two pillars in accordance with embodiments of the present disclosure;

FIG. 6 is a view of the structure containing a dirt and termite chemical mixture deployed in a cellar on top of an open block in accordance with embodiments of the present disclosure; and

FIG. 7 is a perspective view of another system including a structure containing a loose material with termite chemical mixed therein for termite control in accordance with embodiments of the present disclosure.

### DETAILED DESCRIPTION OF THE DISCLOSURE

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Articles “a” and “an” are used herein to refer to one or to more than one (i.e. at least one) of the grammatical object of the article. By way of example, “an element” means at least one element and can include more than one element.

“About” is used to provide flexibility to a numerical endpoint by providing that a given value may be “slightly above” or “slightly below” the endpoint without affecting the desired result.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting” of those certain elements.

Recitation of ranges of values herein are merely intended to serve as a shorthand method of referring individually to each separate value falling within the range, unless otherwise indicated herein, and each separate value is incorporated into the specification as if it were individually recited herein. For example, if a range is stated as between 1%-50%, it is intended that values such as between 2%-40%, 10%-30%, or 1%-3%, etc. are expressly enumerated in this specification. These are only examples of what is specifically intended, and all possible combinations of numerical values between and including the lowest value and the highest value enumerated are to be considered to be expressly stated in this disclosure.

Unless otherwise defined, all technical terms used herein have the same meaning as commonly understood by one of ordinary skill in the art to which this disclosure belongs.

Disclosed herein are systems and methods for controlling termites. These systems and methods provide improved environmentally ways of controlling termites. In accordance with embodiments, the systems and methods can be deployed or implemented at a site (e.g., household or other building) known to have termites or suspected to have termites. The system can include a cardboard or paperboard formed in a suitable shape (e.g., a box or box-like shape) for holding dirt or other suitable loose material. The dirt can be mixed with a termite chemical and placed into the cardboard box. Further, the box (with dirt-chemical mixture inside) can be placed in a termite pathway and left for a suitable time period such that termites can find the box. As an example, the box can be placed in a termite pathway. Examples locations include, but are not limited to, garages, basements, and crawlspaces. It is expected that termites traversing this pathway will enter the box and be exposed to the dirt-chemical mixture. In this case, the termites will return to the termite colony where the chemical can be spread to other termites such that they expire.

These systems and methods are expected to lower the amount of chemical needed to eradicate the termites in an area. This will help to achieve the Environmental Protection Agency's (EPA) goal of reducing the amount of chemicals dispensed into the ground.

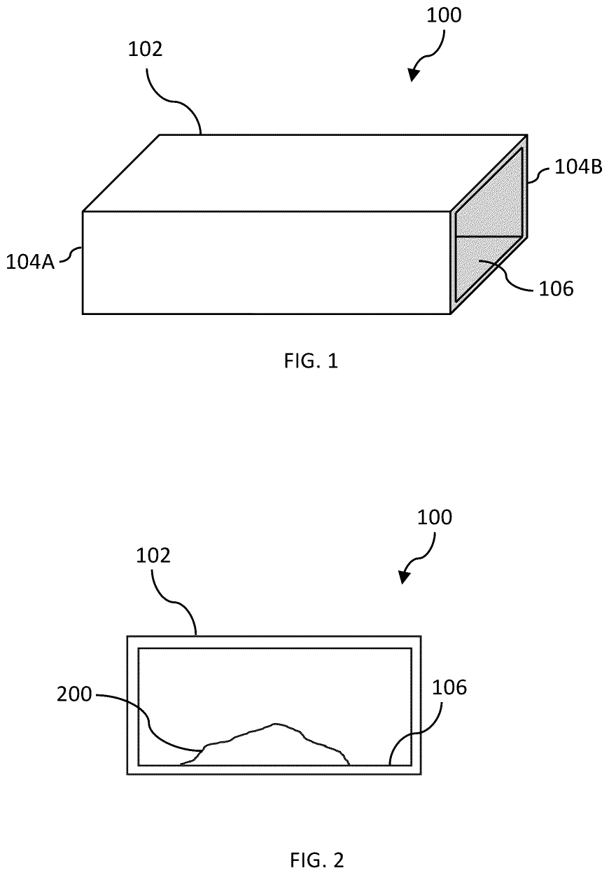

FIG. 1 illustrates a perspective view of a system 100 including a structure 102 containing a loose material (not shown) with termite chemical mixed therein for termite control in accordance with embodiments of the present disclosure. Referring to FIG. 1, the structure 102 defines open ends 104A and 104B into which the loose material can be placed inside the structure 102. In other embodiments, the ends may be closed ends. In other embodiments, one end may be closed, and the other end may be fitted with a removable cap.

The structure 102 is made of cardboard in the example. However, it should be understood that alternatively the structure 102 can be made of any other suitable rigid material. For example, the structure 102 may be made of another paperboard material, plastic, or the like. Also, it is noted that the structure 102 is depicted in this example as a single continuous piece of cardboard material, but it should be understood that the structure 102 may be made of multiple pieces of material of different types. Cardboard is a paper product that termites can and will eat.

The structure 102 is also depicted in this example as being shaped as a box or box-like shape. It should be understood that alternatively the structure 102 may be any other suitable shape.

The system 100 may also include a loose material (not shown in FIG. 1) with termite chemical mixed therein. For example, the loose material may be soil, natural, or artificial material capable of holding and mixing with a termite chemical. An example termite chemical is Termidor SC at a 0.06% solution rate. Termite SC is very effective in HOW is kills the termite colony. Termites travel through treated soil and take the Termidor SC back to the colony where the dying process begins. The chemical can be diluted to a 6% rate, and mixed with dirt in a wheelbarrow. Then time can be allowed for the chemical to properly dry and then placed the “chemical dirt” in the cardboard box.

The loose material with termite chemical mixed in can be placed on an interior surface 106 of the structure 102. In this example, the interior surface 106 is a bottom surface of the interior of the structure 102, but it should be understood that the loose material can be placed on or adhered to any suitable surface of the structure 102 or otherwise placed within the structure 102.

FIG. 2 illustrates a side view of the structure 102 shown in FIG. 1 with a loose material 200 with termite chemical mixed therein. Referring to FIG. 2, the loose material 200 is piled on the surface 106. However, it should be recognized that the loose material 200 may otherwise be suitably arranged within the structure 102. For example, the loose material 200 may be evenly or substantially evenly dispersed within the structure 102. Further, the loose material 200 may be mixed with an effective amount of termite chemical for treatment of termites as will be understood by those of skill in the art.

In embodiments, the system 100 may be suitably placed for treatment of termites. For example, the system 100 may be place within a residence or commercial building. Particularly for example, the system 100 may be deployed in a crawlspace of a house or other residence in accordance with embodiments of the present disclosure.

In embodiments, a kit including the structure 102 and a termite chemical can be provided for use in termite control. The kit can be used to assemble a system, such as the system 100 shown in FIG. 1 for deployment for termite control. As an initial step, the termite chemical can be suitable mixed with loose material (e.g., available soil). Subsequently, the loose material having the termite chemical mixed therewith can be placed on an interior surface of the structure, as shown for example in FIG. 2.

Referring to FIG. 1, this photograph shows the ground where termites come up through the brick. It is not advisable to drill the brick, so the present systems and techniques provides an alternative solution.

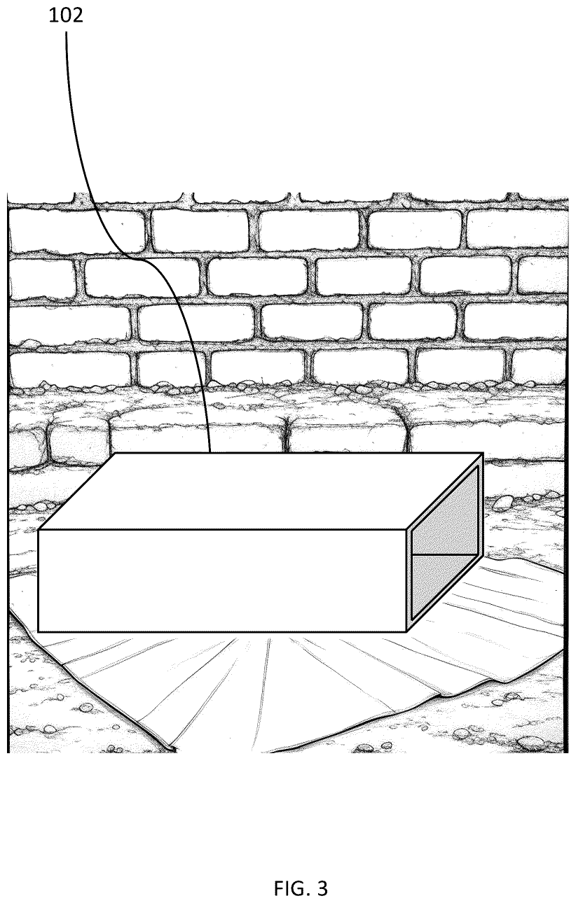

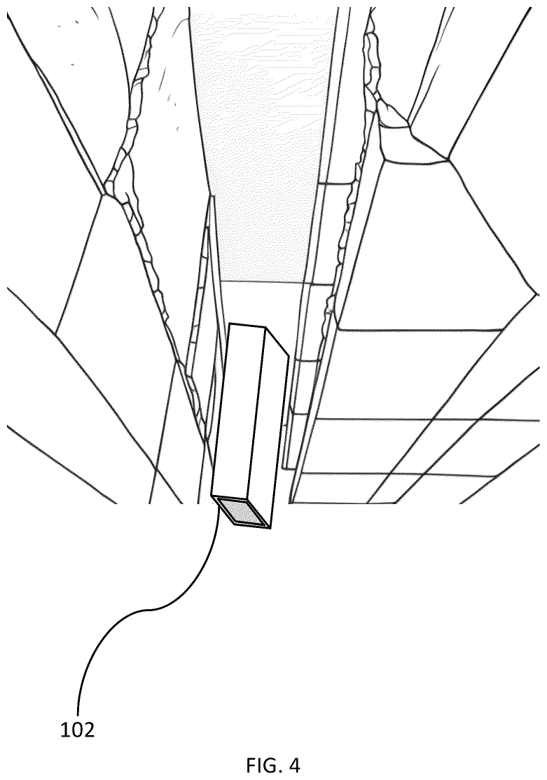

FIG. 3 illustrates the structure 102 containing a dirt and termite chemical mixture deployed in a crawlspace in accordance with embodiments of the present disclosure. Referring to FIG. 2, in this area there can be no trenching or drilling due to space limitations. This placement may be the location of a termite pathway. Thus, it is likely that termites will encounter the structure 102 and be exposed to the chemical therein due to this placement.

FIG. 4 illustrates a view of the structure 102 containing a dirt and termite chemical mixture deployed between two pillars in accordance with embodiments of the present disclosure. Referring to FIG. 4, in this area there can be no trenching or drilling due to space limitations.

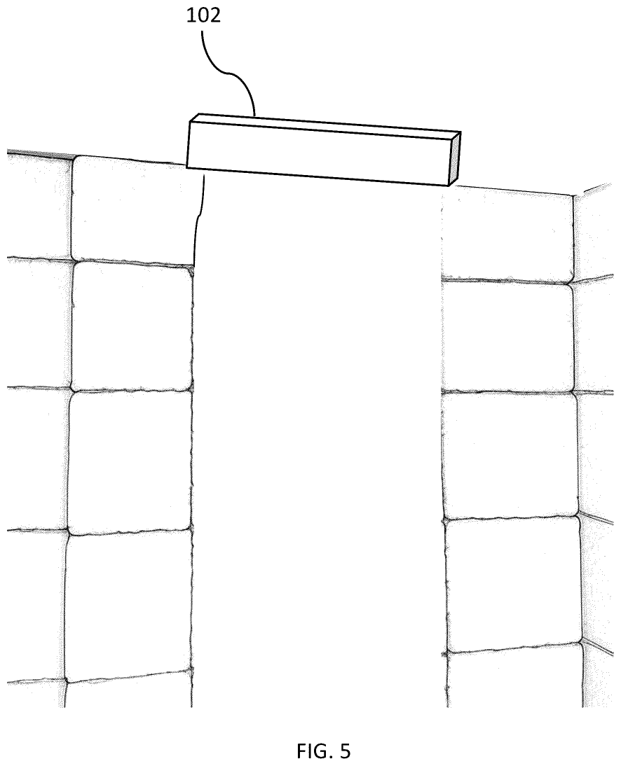

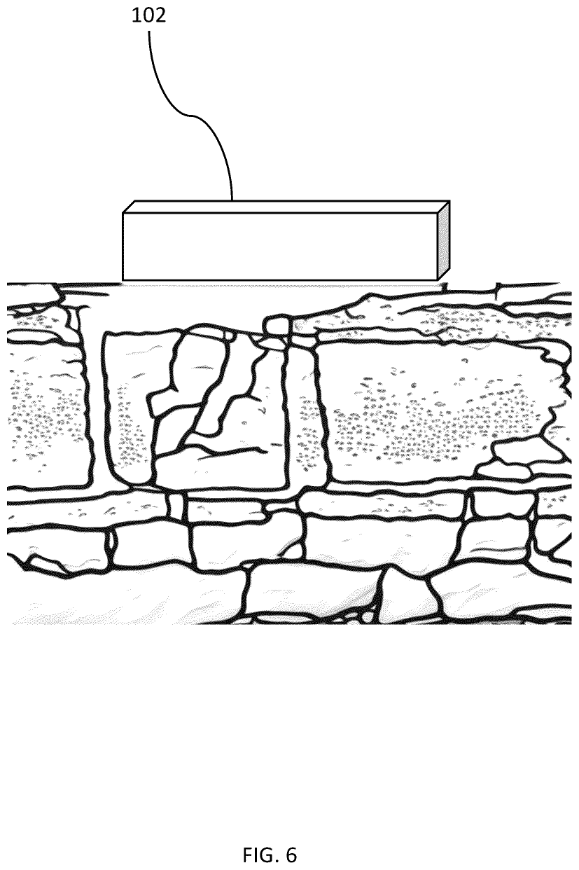

FIG. 5 illustrates a view of the structure 102 containing a dirt and termite chemical mixture deployed in a crawlspace on top of two pillars in accordance with embodiments of the present disclosure. Referring to FIG. 5, in this area there can be no trenching or drilling due to space limitations.

FIG. 6 illustrates a view of the structure 102 containing a dirt and termite chemical mixture deployed in a cellar on top of an open block in accordance with embodiments of the present disclosure. Referring to FIG. 6, in this area there can be no trenching or drilling due to space limitations.

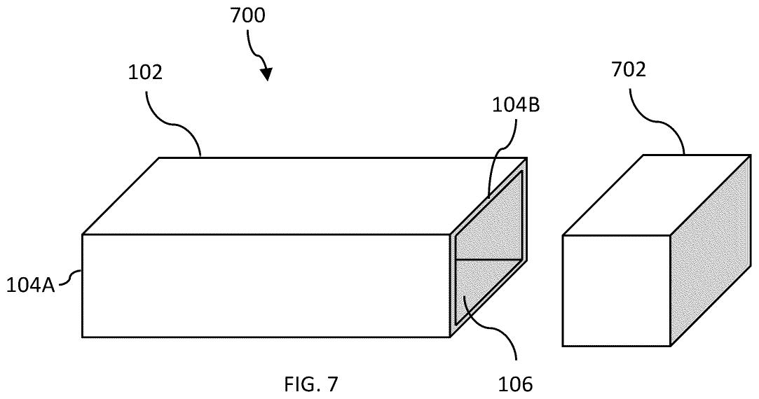

FIG. 7 illustrates a perspective view of another system 700 including a structure 102 containing a loose material (not shown) with termite chemical mixed therein for termite control in accordance with embodiments of the present disclosure. Referring to FIG. 7, the structure 102 is similar to the structure 102 shown in FIG. 1 except that the end 104A is closed such that the interior cannot be accessed. End 104B is open in this example.

With continuing reference to FIG. 7, the system 700 includes a removable cap 702. The cap 702 is shown spaced apart from the structure 102. But the cap 702 can be moved leftward to thereby close the open end 104B. Thereby, the open end 104B is closable by fitting of the removable cap 702 thereon. The removable cap 702 is sized and shaped to fit to the open end 104B.

The following are a few examples and procedures described in which cardboard containers or other suitable containers may be used to significantly reduce the amount of chemical dispersed in the ground while still helping to protect structures from termites.

### Example Scenarios

A customer can contact the pest control company to either acquire termite remediation because they have termite evidence or to acquire a treatment for prevention of termites. Once evaluated, the cardboard container may be used for either remediation or prevention either stand alone or in conjunction with a traditional treatment. The Pest Control Operator can determine the number of cardboard containers needed and the proper placement of the containers.

Termite chemical can be mixed with soil and placed inside the cardboard container. There can be end caps or lids to prevent the soil from spilling from the cardboard container.

For a structure with the crawlspace, the cardboard containers can be placed inside the crawlspace either at ground level or along the seal plate, at the top of pillars, in between pillars where a tool may not fit and anywhere termite evidence is observed. The cardboard container can be placed continuously along the crawlspace perimeter or seal plate for a very aggressive treatment or prevention.

For a structure built on a slab: the cardboard container can be placed inside the structure at the point of infestation. This can help rectify the need to remove flooring and drilling the concrete slab. A small cut in the sheetrock can allow access for the cardboard container in the wall and may be less intrusive than drilling the floor. The cardboard container can be placed in bath traps, under kitchen and bathroom sink where plumbing lines come into the house through the concrete slab and any area that termite evidence is observed.

For outside the structure: if termites are found to be entering the structure from the outside perimeter, the cardboard container can be placed in a small trench dug next to the structure. The cardboard container can be placed in a plastic cradle for easy removal once the termites have been remediated or for the tenure of the efficacy of the termite chemical. The cradle can remedy leftover cardboard in the soil. This method could be used for remediation or prevention and could be used around the perimeter of the structure. With the plastic cradle, the soil can be salvaged at the end of efficacy and reused for another termite treatment.

For porches: the cardboard container can be placed at the expansion joint next to the structure for active termites. This may be especially be helpful for slate or tile porches that homeowners do not want to drill.

For attics: the cardboard container can be placed in an attic where there is evidence of termites. This was a successful treatment that was a difficult situation due to the electrical wiring and insulation that could not be exposed to a liquid treatment.

Example goals for use of the systems and methods described herein include, but are not limited to: Reduce the amount of chemicals injected into the soil to help protect the environment; Reuse any undamaged cardboard containers for the next termite project; Reuse the soil to reduce the amount of chemicals in the environment; Better monitoring of termite activity; and Increased homeowner participation since the cardboard container can easily be observed in most places.

Once the termite chemical efficacy has expired, any soil can be retreated and reused for another termite treatment, or the soil could safely be placed in the environment. If not damaged, the cardboard could be reused for another treatment. If damaged, the cardboard can be cleaned with any soap and water solution and triple rinsed to be trash ready. The current requirement for most raw material pesticides is to triple rinse the container with water and puncture to render it useless.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment, but rather should be construed in breadth and scope in accordance with the appended claims.

1. A system for termite control, the system comprises:
a structure having an interior surface; and
a loose material with termite chemical mixed therein, wherein the loose material is placed on the interior surface.

2. The system of claim 1, wherein the structure is made of paperboard.

3. The system of claim 1, wherein the structure is made of cardboard.

4. The system of claim 1, wherein the structure is shaped into a box or box-like shape.

5. The system of claim 1, wherein the system is placed in a termite pathway.

6. The system of claim 1, wherein the structure defines at least one open end.

7. The system of claim 2, wherein the structure defines a first open end and a second open end.

8. The system of claim 1, further comprising a removable cap, and
wherein the structure defines an open end that is closable by fitting of the removable cap thereon.

9. The system of claim 8, wherein the removable cap is sized and shaped to fit to the open end.

10. The system of claim 1, wherein the structure defines an open end that provides a pathway to the interior surface.

11. A method for termite control, the method comprises:
providing a structure having an interior surface with loose material placed on the interior surface, wherein the loose material contains a termite chemical; and
placing the structure in a termite pathway.

12. The method of claim 11, wherein the structure is made of paperboard.

13. The method of claim 11, wherein the structure is made of cardboard.

14. The method of claim 11, wherein the structure is shaped into a box or box-like shape.

15. The method of claim 11, wherein the structure defines at least one open end.

16. The method of claim 15, wherein the structure defines a first open end and a second open end.

17. The method of claim 11, further comprising a removable cap, and
wherein the structure defines an open end that is closable by fitting of the removable cap thereon.

18. The method of claim 17, wherein the removable cap is sized and shaped to fit to the open end.

19. The method of claim 11, wherein the structure defines an open end that provides a pathway to the interior surface.

20. A kit for termite control, the kit comprises:
a structure having an interior surface; and
a termite chemical for mix with a loose material for placement on the interior surface.
